(19) United States
(12) Patent Application Publication
(10) Pub. No.: US 2002/0133537 A1
(43) Pub. Date: Sep. 19, 2002

(54) Server cluster and server-side cooperative caching method for use with same

(75) Inventors: Francis Chi Moon Lau, Hong Kong (CN); Cho-Li Wang, Hong Kong (CN); K. P. Chow, Hong Kong (CN); Ronald H.Y. Chung, Hong Kong (CN); Roy S.C. Ho, Hong Kong (CN); David C.M. Lee, Hong Kong (CN); Y. F. Sit, Hong Kong (CN)

Correspondence Address: Henricks, Slavin & Holmes LLP, Attn: Craig A. Slavin, Esq., Suite 200, 840 Apollo Street, El Segundo, CA, 90245, US

(73) Assignee: Whizz Technology Ltd.

(21) Appl. No.: 09/805,340

(22) Filed: Mar. 12, 2001

(51) Int. Cl. G06F 15/16; G06F 15/167

(52) U.S. Cl. 709/203; 709/219

(57) ABSTRACT

A server system and method that allows data to be cooperatively cached such that data objects cached by the servers in a server cluster may be shared with the other servers in the cluster.

### BACKGROUND OF THE INVENTIONS

1. Field of Inventions

The present inventions relate generally to data networks and, more particularly, to server clusters.

2. Description of the Related Art

The Internet and other wide area networks (collectively “the Internet”) have become ubiquitous in recent years. One typical transaction is a clientserver transaction where a client device, such a personal computer, Internet device or terminal executes a web browser application that issues commands to servers via the Internet. The commands are in the form of universal resource locators (“URLs”), which can be translated into internet protocol (“IP”) addresses and specific data object retrieval commands. Retrieved data objects include, but are not limited to, web pages, sound files, video files, image files, streaming multimedia clips, and software programs such as Java applets and ActiveX controls. As used herein, the term “data object” encompasses any information or program that is transmitted from a server to a client.

The volume of the data objects being transferred from servers to clients has increased dramatically in recent years. The increase in volume has resulted in congestion and latency at various points within the Internet, even as system bandwidth expands to meet the demand. One attempt to reduce congestion and latency involves the use of centralized proxy servers, which are Internet servers located between a number of client devices and the remote servers that store the desired data objects. A proxy server typically caches data objects, such as data objects requested by a first client device (in anticipation of subsequent client device requests) and frequently requested data objects. When a proxy server receives a request for a particular data object, it looks for the data object in its local cache. If the data object is available in its local cache, it immediately provides the data object to the requesting client device (without visiting the remote server), thereby reducing latency and Internet congestion. Otherwise, the proxy server fetches the data object from the remote server, saves a copy in the local cache for use in response to subsequent requests, and then provides the data object to the requesting client device. Data objects are typically removed from the proxy server cache according to factors including data object age, size, and access history, as well as the size and status of the cache itself.

A variety of client-side caching schemes have also been introduced in order to reduce latency and increase bandwidth efficiency. Here, frequently accessed data objects are stored either by the client device itself or by a server or other caching device within a local area network (“LAN”) that consists of multiple client devices connected to a high bandwidth network. One example of client-side caching performed by a client device itself is the caching scheme performed by many Internet browsers. The browser uses memory allocated for caching at the client device to cache retrieved data objects. Turning to LANs, client-side caching may be performed by a proxy server. Such proxy servers may be used, for example, as both a cache proxy and a firewall proxy which acts as the gateway between the LAN and the Internet. The cache proxy stores data objects retrieved from remote servers, as well as other data objects that are frequently requested by the client devices on the LAN, and services requests for the stored data objects from the client devices. As a result, both latency and Internet bandwidth consumption are reduced.

Attempts have also been made to improve efficiency on the server-side of client-server transactions. As used herein, the term “server-side” is used to identify the LAN where the servers are located. Server clusters have been introduced in order to satisfy the demands associated with ever increasing numbers of Internet clients and data objects of ever increasing size. Server clusters typically consists of a plurality of servers, a single request dispatcher, and one or more data storage devices all connected to one another by a high bandwidth LAN. Requests for data objects from client devices and proxy servers are transmitted to the dispatcher via the Internet. The requests are then distributed to available servers by the dispatcher. Once a server receives a request, the server retrieves the requested data object and transmits the data object to the requesting client device. Among the benefits of server clusters are increased server availability, manageability, and scalability.

The present inventors have determined, however, that server clusters can be another source of latency and that this source of latency has heretofore gone unresolved. For example, bottlenecks can develop at the data storage devices when they are being simultaneously accessed by many or all of the servers within the server cluster.

### SUMMARY OF THE INVENTIONS

Accordingly, a general object of the present inventions is to reduce some of the latencies associated with client-server transactions. Another object of the present inventions is to reduce some of the latencies associated with server clusters.

In order to accomplish some of these and other objectives, a server system in accordance with a present invention includes a plurality of servers and apparatus that allows data to be cooperatively cached such that data objects cached by the servers may be shared with the other servers.

In order to accomplish some of these and other objectives, a server-side caching method in accordance with another invention, and which may be employed in conjunction with a server system having a plurality of servers, includes the steps of receiving a client request for a data object, determining whether the data object is being cached by the server that received the client request, determining whether a server that did not receive the client request is caching the data object in response to a determination that the server that received the client request is not caching the data object, and obtaining a copy of the data object from the cache storage device of a server that did not receive the client request.

There are a number of advantages associated with the inventions described herein. For example, when a server receives a client request for a data object that is not cached locally, the server may be able to obtain a copy of that data object from one of the other servers in the cluster instead of from the centralized storage device. As a result, the latencies attendant to obtaining data objects from a centralized storage device will be eliminated each time a server can bypass the centralized storage device and obtain a copy of a requested data object from the cache of another server in the cluster.

The above described and many other features and attendant advantages of the present inventions will become apparent as the inventions become better understood by reference to the following detailed description when considered in conjunction with the accompanying drawings.

### BRIEF DESCRIPTION OF THE DRAWINGS

Detailed description of preferred embodiments of the inventions will be made with reference to the accompanying drawings.

FIG. 1 is a block diagram showing a client-server system in accordance with one embodiment of the present invention.

FIG. 2 is a block diagram of a server cluster in accordance with one embodiment of a present invention.

FIG. 3 is a flow chart showing the operation of a server-side cooperative caching system in accordance with a preferred embodiment of a present invention.

FIG. 4 is a flow chart showing the operation of a web server process in accordance with a preferred embodiment of a present invention.

### DETAILED DESCRIPTION OF THE PREFERRED EMBODIMENTS

The following is a detailed description of the best presently known modes of carrying out the inventions. This description is not to be taken in a limiting sense, but is made merely for the purpose of illustrating the general principles of the invention. Additionally, its is noted that detailed discussions of various operating components of client devices, servers, the Internet, and LANS, which are not pertinent to the present inventions have been omitted for the sake of simplicity.

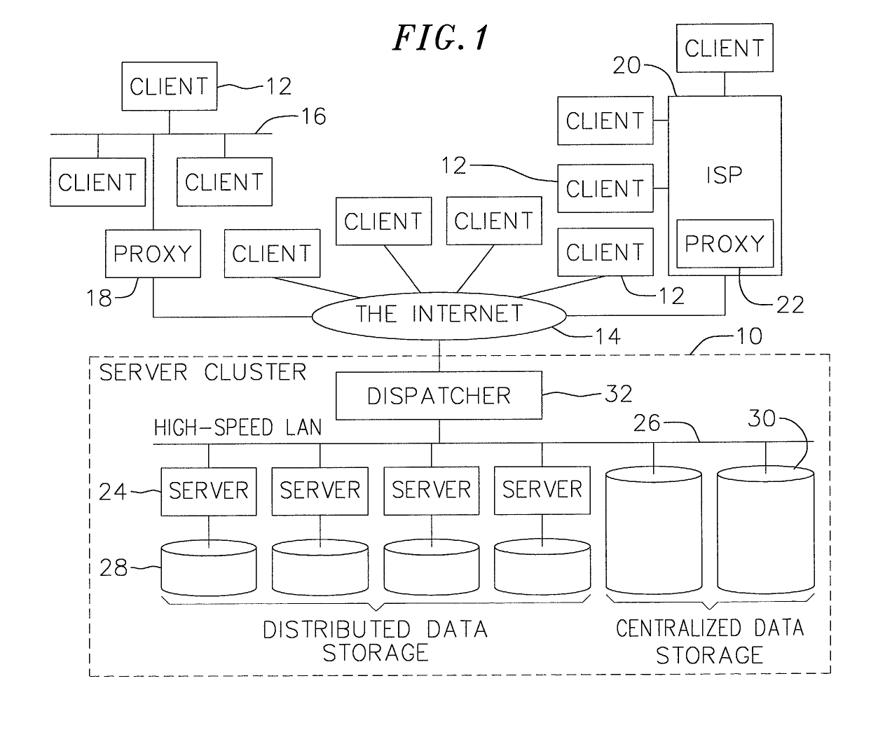

The present inventions are illustrated in the context of a system where client devices are connected to a server cluster by way of the Internet. As those of skill in the art would readily recognize, the inventions herein are also applicable to systems where client devices access a server cluster by way of other types of networks such as intranets, extranets and virtual private networks (“VPNs”). As illustrated for example in FIG. 1, an Internet server cluster 10 in accordance with one embodiment of a present invention may be connected to client devices 12 (i.e. personal computers, internet appliances, personal digital assistants, telephones and any other devices capable of requesting data objects from a server) via the Internet 14 in a variety of ways. Client devices 12 may, for example, be directly connected to the Internet 14, or may be connected to the internet by way of a network 16 that includes its own proxy server 18, or may be connected to the Internet by way of an internet service provider (ISP) 20 having one or more proxy servers 22. The client devices 12 and proxy servers 18 and 22 may each be used to cache data objects through the use of various client-side caching schemes.

The exemplary server cluster 10 includes a plurality of servers 24 that are connected to one another over a high speed LAN 26 and include respective distributed data storage devices 28 (i.e. local hard disks and/or other types of storage devices). Data objects are permanently stored in centralized storage devices 30 such as, for example, network file servers, redundant arrays of inexpensive disks (“RAIDs”) and network attached secure disks (“NASDs”). There may also be some instances where some data objects are permanently stored (as opposed to temporarily cached) by the distributed data storage devices 28, although this is not the case in the exemplary embodiments. The exemplary server cluster 10 is also provided with a dispatcher 32 that accepts incoming requests for data objects from the client devices 12 and then distributes the requests to the servers 24. In the absence of the cooperative server-side caching methods and apparatus described below, the server 24 that is chosen to serve the request (preferably an available server) would simply retrieve the requested data object from one of the centralized data storage devices 30 and reply the client device 12 with the retrieved data object in conventional fashion.

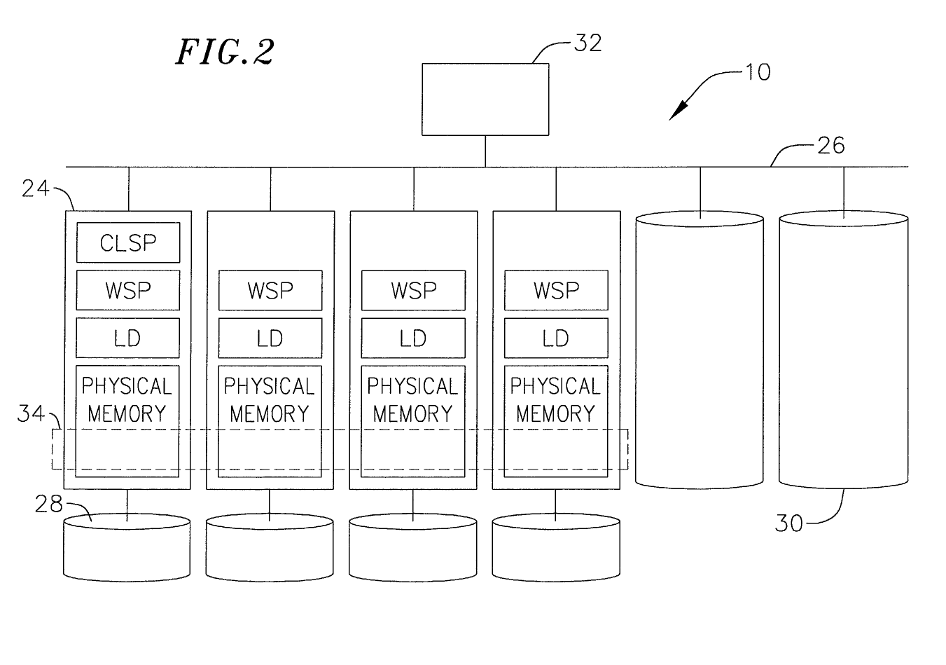

In accordance with the present invention, a plurality (and preferably all) of the servers 24 in the cluster 10 contribute respective portions of their storage capability (such as portions of their physical memory and/or local hard disk space depending on the particular server cluster configuration) to form a large, distributed server-side cache 34. The distributed server-side cache 34, which in the preferred embodiment only includes the server's physical memory as shown in FIG. 2, may be used in a cooperative server-side caching system that allows a server 24 which receives client requests for a data object that the server does not have in its own cache to obtain a copy of the data object without accessing the centralized data storage devices 30.

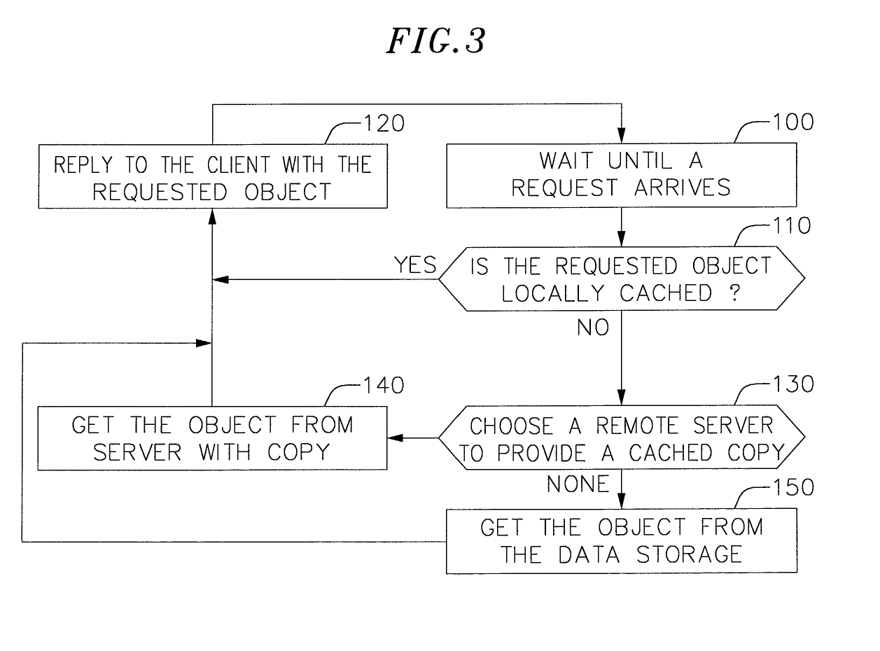

The cooperative caching system generally operates in the manner illustrated in FIG. 3. When a client request for a data object is received by one of the servers 24 (“the receiving server”) (Step 100), it is first determined whether the data object is stored in the receiving server's local cache (Step 110) and, if it is, the receiving server replies to the client 12 with the requested data object (Step 120). If the data object is not stored in the receiving server's local cache, it is determined whether the data object is stored somewhere within the distributed server-side cache 34 (Step 130). If the data object is stored within the distributed server-side cache 34, then the receiving server 24 obtains a copy of the data object from the server in which the data object is cached (Step 140) through a cache forwarding operation and then transmits the data object to the client 12 (Step 120). As a result, the latency associated with retrieving the data object from one of the centralized data storage devices 30 is reduced. The reduction in latency associated with the present invention is especially pronounced when the centralized data storage devices 30 are shared among all of the servers 24 and the workload of the centralized data storage devices is high. A data object that is not stored within the distributed server-side cache 34 is retrieved from one of the centralized data storage devices 30 (Step 150) by the receiving server 24 and is then transmitted to the requesting client 12 (Step 120). The data object is also at least temporarily cached by the receiving server 24 within the distributed server-side cache 34 so that it will be available for future client requests received by any of the servers 24 in the server cluster 10 to reduce latency in the future.

The present cooperative server-side caching system operates in accordance with a number of predefined parameters or “policies.” These policies are the “search” policy, which defines how incoming requests for data objects are handled, the “garbage collection” policy, which defines how data objects are removed from cache to reclaim cache space, the “cache replication” policy, which determines whether more than one server should cache a particular data object, and the “load balancing” policy, which specifies how to the load on the servers is to be defined for load balancing purposes. Specific examples of each policy are discussed in detail below in the context of the exemplary Internet server cluster 10 illustrated in FIG. 2 and the cooperative caching system illustrated in FIG. 3.

Referring again to FIG. 2, each of the servers 24 in the Internet server cluster 10 hosts a web server process (“WSP”) and a load daemon process (“LDP”), while one of the servers also hosts a cache load server process (“CLSP”). The WSP is the process that serves the requests for data objects that the servers 24 receive from the client devices 12. In the exemplary embodiment, the WSPs are conventional Apache web server processes that have been modified to execute the present policies. The LDPs monitor local loading at the respective servers 24 and periodically transmit the local loading information to the CLSP. The CLSP also maintains a cache status table that includes a list of the data objects cached by each of the servers 24.

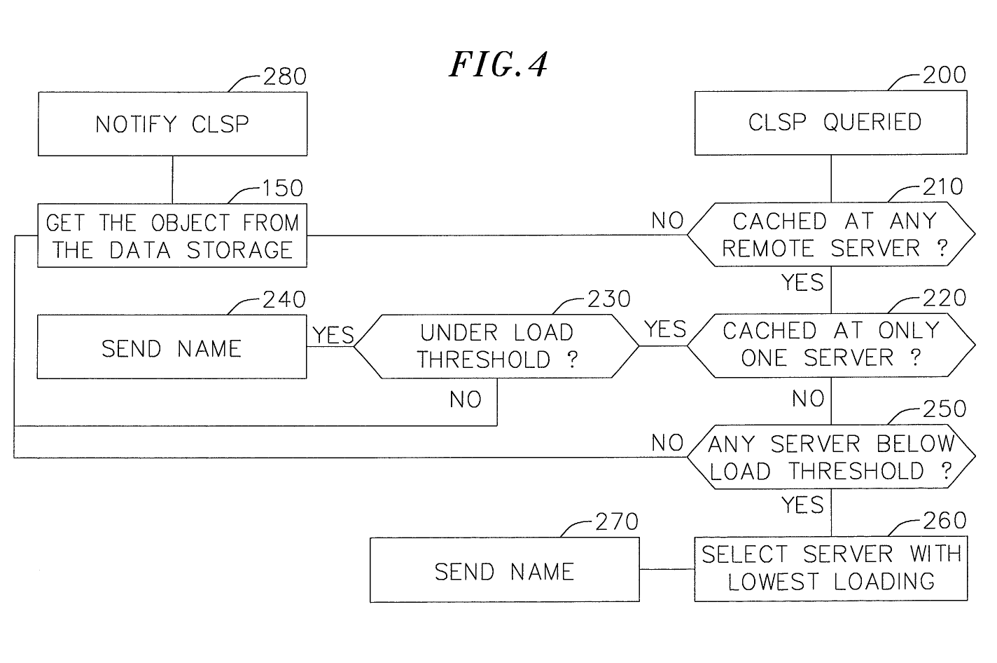

The exemplary search and load balancing policies for the Internet server cluster 10 operate as follows. When one of the servers 24 receives a data object request from a client, the WSP in the receiving server first determines if the requested data object is cached locally (i.e. in the portion of the distributed server-side cache 34 associated with the receiving server) and, if the data object is cached locally, it is retrieved and forwarded to the requesting client (Steps 100, 110 and 120). If the data object is not cached locally, then the WSP determines whether the data object is cached in any of the other servers in the cluster 10 (Step 130). As illustrated for example in FIG. 4, the WSP makes this determination in the exemplary embodiment by querying the CLSP (Step 200), which maintains the aforementioned cache status table. The CLSP then proceeds based on the information in the cache status table and the loading of any server that includes the requested data object.

More specifically, the CLSP first determines if the requested data object is being cached within the distributed server-side cache 34 (Step 210). The CLSP will instruct the receiving server (i.e. the server that received the client request) to obtain the data object from one of the centralized data storage devices 30 (Step 150) if the requested data object is not cached. The receiving server 24 will also cache the data object and inform the CLSP that it has done so that the cache status table may be updated (Step 280).

If the requested data object is cached in exactly one server 24 in the distributed server-side cache 24 (Step 220), and if the loading of that particular server does not exceed a pre-defined loading threshold (e.g. 90% of the maximum possible server loading) (Step 230), then the CLSP will send the name of that server to the WSP in the receiving server (Step 240). The WSP in the receiving server 24 will then request that the server which is caching the requested data object forward the data object to the receiving server. This allows the receiving server to avoid the latency associated with retrieving the data object from one of the centralized data storage devices 30. However, if the single server 24 that is caching the data object is above the loading threshold, then the CLSP will instruct the receiving server 24 to obtain the data object from one of the centralized data storage devices 30 (Step 150). The receiving server 24 will also cache the data object and inform the CLSP that it has done so (Step 280).

If, on the other hand, the CLSP determines that the requested data object is cached in more than one of the servers 24 in the distributed server-side cache 34 (Step 250), then the server with the lowest loading will be chosen (Steps 260 and 270), assuming that the loading does not exceed the loading threshold. If none of the servers 24 that are caching the data object are below the loading threshold, the receiving server will simply retrieve the data object from the appropriate one of the centralized data storage devices 30 (Step 150), transmit the data object to the requesting client 12, and inform the CLSP that it has fetched and cached a copy of the data object so that the cache status table may be updated (Step 280).

Server loading is defined in terms of one or more server operation parameters, taken alone or in combinations that are suitable for particular applications. Server loading in the exemplary embodiment is defined by the CPU load represented as a percentage of the total CPU capacity. Other exemplary parameters include, but are not limited to, the number of network connections, the level of network communication, the number of running processes, memory usage, and the level of hard disk activities.

The present search policy may also be implemented in other ways. For example, a plurality of CLSPs can be run in a subset of the available servers 24 to avoid performance bottlenecks. Here, the loading of each of the servers 24 is periodically broadcast to all of the CLSPs. When a server 24 receives a client request, it chooses one of the CLSPs based on a simple hash function performed on the request that attempts to balance the workload of the CLSPs. For example, the modulus of the name of the requested data object may be computed and transformed into a specific ID that identifies a CLSP for query. Other hash functions may be also applied for different system configurations and request patterns of the data objects. Consequently, each CLSP maintains only a portion of the total caching status information.

It should be noted that the individual servers 24 may not have a complete picture on the cooperative cache, i.e. may not have complete information about the cache contents of the other servers, because the CLSP does not provide a full list of data objects in response to each request. A full list is not provided in response to each request because this could result in excessive network communication and poor system performance. Each server 24 may, however, provide information about the data objects being forwarded (such as request rate and replication information) during cache forwarding operations. This enables the servers 24 to construct a partial list of the data objects stored in the cooperative cache 34 that may be used to improve the system-wide accuracy of the garbage collection and cache replication policies. This approach is believed to be a good balance between the accuracy of the policies and the efficiency of the supporting network protocol.

Preferably, when a server 24 performs a cache forwarding operation, it will forward information to the receiving server about the data object in addition to the data object itself. Such information includes the data object's request rate and a replication recommendation. The request rate is one of the considerations for the garbage collection policy (discussed below). The replication recommendation is determined by the server 24 performing the forwarding operation based on the popularity of the data object in the forwarding server's local cache. If the data object is sufficiently popular, then the forwarding server 24 recommends that the receiving server maintain a local copy of the data object in its cache. If not, the forwarding server 24 recommends that the receiving server discard the data object after sending a copy to the requesting client. The replication recommendation, therefore, plays a crucial role in controlling of level of replication of cached data objects. The various possible basis for the recommendation is discussed in greater detail below.

With respect to the garbage collection policy, which defines how data objects are removed from cache to reclaim cache space, the WSP of a server 24 will begin to remove data objects from it's cache in accordance with a garbage collection algorithm when the cache reaches a predetermined upper usage level (such as, for example, 90%). The server 24 will continue to remove data objects from the cache until the cache reaches a lower usage level (such as, for example, 70%). Suitable examples of garbage collection algorithms that are particularly useful in Internet server applications are “earliest expiration,” “least recently used,” “least frequently used,” “least recently used/minimum,” and “least frequently used/minimum.” These garbage collection algorithms are discussed briefly below. Nevertheless, it should be noted that garbage collection algorithms should be chosen based on the intended application of the server cluster. The garbage collection algorithms used in a multi-media server cluster, for example, may be different than a server cluster that is primarily used to deliver web pages because parameters such as the size of the cached data objects, protocols, caching methods and delivery mechanisms are different for the multi-media server.

As the name implies, an earliest expiration algorithm removes data objects from the cache in the order that they will expire, the earliest being removed first. One example of a data object that may expire quickly is a web page. The earliest expiration algorithm is useful in those instances where it is important that the cache contain the most up-to-date versions of the data objects. In other instances, such as pictures that are seldom modified, the popularity of a frequently requested data objects is typically much higher than the others in the cache, regardless of the order of expiration. Here, the earliest expiration algorithm may result in the removal of popular data objects before they actually expire and necessitate retrievals from one of the data storage devices 28 and 30 that would have been otherwise unnecessary.

Least recently used is a common algorithm that removes the data objects from the cache that were requested less recently prior to those that have been requested more recently. The underlying assumption is that a data object that has been requested recently is likely to be requested again before those data objects that have not been requested recently. It should be noted that this assumption is not necessarily true because a recently requested data object is not necessarily a popular data object.

Least frequently used is an algorithm that keeps popular data objects (i.e. the data objects that have been requested the most) in the cache by removing those data objects that are less popular first. While this approach is commonly used in conjunction with Internet servers, it does not adapt well to changes in client request patterns. For example, a particular data object may be requested many times within a short period of time and then not requested again. This data object will nevertheless remain in the cache for a relatively long time because of the large number of requests. Aging techniques are usually employed to obviate this problem.

Least recently used/minimum is similar to least recently used. Here, however, the size of the cached data objects is the primary consideration and how recently the data objects were requested is the secondary consideration. Larger data objects are removed prior to smaller data objects in order to minimize the total number of cached data objects that are removed. This algorithm is particularly useful in Internet server applications because data objects that are popular on the Internet tend to be small.

Least frequently used/minimum is similar to least frequently used. Here, the popularity of the data objects is the primary consideration and the size of the data objects is the secondary consideration. This algorithm is particularly useful in applications such as software repositories where large data objects tend to be popular and the latencies associated with retrieving a large data object from one of the centralized data storage devices 30 are greater than those associated with retrieving a number of smaller data objects with lower popularity. Aging techniques are usually employed to allow the algorithm to adapt to changes in client request patterns.

As noted above, the cache replication recommendation is made by the server 24 that is forwarding the data object to the receiving server because it possesses the best knowledge concerning the data object. In preferred implementations, the cache replication recommendation is based on a cache replication parameter in the form of a hit rate percentage X. The hit rate percentage X, which is the threshold for replicating a cached data object, is indicative of a particular data object's hit ranking with respect to the other data objects cached by the server 24 that is caching the requested data object. The cache replication recommendation will be made in a basic implementation whenever the hit rate percentage for a particular object X_{OBJ} is greater than a predetermined recommendation percentage X_{REC}.

It may nevertheless be desirable in some situations not to make the cache replication recommendation, even when the hit rate percentage for the requested data object X_{OBJ} is greater than the recommendation percentage X_{REC}. If, for example, the hit rate percentage X_{OBJ} is greater than the hit rate percentage of the data object with a hit rate percentage that ranks just above X_{REC} (i.e. the object with hit rate percentage X_{REC+1}), then the server 24 that will be forwarding the data object to the receiving server will also forward a replication recommendation. Assuming that the server 24 which is caching the data object is the only server caching this data object, the data object would now be cached on two servers, and further assuming that the overall client request rate remained constant, the hit rate percentage at each server caching this data object would eventually go to X_{OBJ}/2. A hit rate percentage of X_{OBJ}/2 may not be above the recommendation percentage X_{REC}. Here, subsequent forwarding operations will not include a cache replication recommendation. The reduced hit rate percentage could also result in removal of the data object from cache during subsequent garbage collection procedures. In other words, a popular data object could be removed from cache because it has been replicated. One way to minimize the number of instances where popular data objects are unnecessarily removed is to withhold the replication recommendation unless X_{OBJ} is the greater than twice the hit rate percentage X_{REC+1}. This is, however, a relatively extreme solution, especially given the fact that the hit rate will not necessarily drop to X_{OBJ}/2 on each of the servers 24.

On balance, the basic implementation of the cache replication policy will cause popular data objects to be diffused into in the caches of a number of the servers 24 in the server cluster 10, while excessive replication will be limited by corresponding decreases in the respective per server hit rates for those data objects. Therefore, different cached objects stored in the cooperative cache would have different degrees of replication, depending on their individual popularity.

Although the present inventions have been described in terms of the preferred embodiments above, numerous modifications and/or additions to the above-described preferred embodiments would be readily apparent to one skilled in the art. It is intended that the scope of the present inventions extends to all such modifications and/or additions.

We claim:

1. A server-side caching method for use with a server cluster including at least one central storage device and a plurality of servers having respective cache storage devices, the method comprising the steps of:
receiving a client request for a data object from a client device with one of the servers;
determining whether the data object is being cached by the server that received the client request;
determining whether a server that did not receive the client request is caching the data object in response to a determination that the server that received the client request is not caching the data object;
obtaining a copy of the data object from the cache storage device of a server that did not receive the client request in response to a determination that the server that received the client request is not caching the data object and a determination that the data object is cached in a server that did not receive the client request; and
transmitting the data object to the client device.

2. A method as claimed in claim 1, wherein the step of transmitting the data object to the client device comprises:
transmitting the data object from the server that received the client request to the client device in response to a determination that the data object is being cached by the server that received the client request.

3. A method as claimed in claim 1, wherein the step of transmitting the data object to the client device comprises:
sending the copy of the data object from the cache storage device of a server that did not receive the client request to the server that received the client request; and
sending the copy of the data object from the server that received the client request to the client device.

4. A method as claimed in claim 3, further comprising the step of:
sending at least one of data object request rate information and a data object replication recommendation to the server that received the client request with the copy of the data object.

5. A method as claimed in claim 1, wherein the step of transmitting the data object to the client device comprises:
sending a copy of the data object from the central storage device to the server that received the client request in response to a determination that the server that received the client request is not caching the data object and a determination that the data object is not cached in a server that did not receive the client request.

6. A method as claimed in claim 5, further comprising the step of:
caching the copy of the data object in the cache storage device of the server that received the client request.

7. A method as claimed in claim 1, further comprising the step of:
maintaining a cache status table including a list of data objects stored in the respective cache storage devices of the plurality of servers.

8. A method as claimed in claim 7, wherein the step of determining whether a server that did not receive the client request is caching the data object comprises:
querying the cache status table.

9. A method as claimed in claim 7, wherein the step of transmitting the data object to the client device comprises:
sending a copy of the data object from the central storage device to the server that received the client request in response to a determination that the server that received the client request is not caching the data object and a determination that the data object is not listed in cache status table.

10. A method as claimed in claim 9, further comprising the steps of:
caching the data object in the cache storage device of the server that received the client request; and
updating the cache status table to reflect that a copy of the data object has been cached in the server that received the client request.

11. A method as claimed in claim 1, wherein the step of obtaining a copy of the data object from the cache storage device of a server that did not receive the client request comprises:
obtaining a copy of the data object from the cache storage device of a server is operating below a predetermined load threshold.

12. A server system for use with a plurality of client devices, comprising;
a local area network adapted to be connected to a wide area network;
a plurality of servers connected to the local area network and having respective cache storage devices adapted to cache data objects; and
a cache load server process running on at least one of the servers that maintains a list of data objects cached in the cache storage devices.

13. A server system as claimed in claim 12, wherein each of the servers runs a load daemon process that monitors server loading and transmits server loading information to the cache load server process.

14. A server system as claimed in claim 12, wherein each of the servers runs a web server process that receives requests for data objects from client devices and queries the cache load server process to determine whether another server is caching a requested data object in response to a determination that the associated server is not caching the requested data object.

15. A server system as claimed in claim 14, wherein the web server processes queries the cache load server process to determine whether a server that is caching a requested data object is below a predetermined server loading threshold.

16. A server system as claimed in claim 12, further comprising:
a dispatcher adapted to connect the local area network to the wide area network.

17. A server system as claimed in claim 12, further comprising:
at least one central storage device connected to the local area network.

18. A server system for use with a plurality of client devices, comprising;
a local area network adapted to be connected to a wide area network;
a plurality of servers connected to the local area network and having respective cache storage devices adapted to cache data objects; and
means for cooperatively caching data objects within the cache storage devices such that cached data objects may be shared by the plurality of servers.

19. A server system as claimed in claim 18, wherein each of the servers includes means for receiving a client request for a data object from a client device and means for determining whether the data object is being cached locally.

20. A server system as claimed in claim 18, wherein the means for cooperatively caching data objects includes means for determining whether a server that did not receive the client request is caching the data object.

21. A server system as claimed in claim 20, wherein the means for cooperatively caching data objects includes means for determining whether a server that did not receive the client request and is caching the data object is operating below a predetermined loading threshold.

22. A server system as claimed in claim 18, further comprising:
a dispatcher adapted to connect the local area network to the wide area network.

23. A server system as claimed in claim 18, further comprising:
at least one central storage device connected to the local area network.
